(19) United States
(12) Patent Application Publication
(10) Pub. No.: US 2006/0262543 A1
(43) Pub. Date: Nov. 23, 2006

(54) Base for a lamp

(75) Inventors: Thomas Schmidt-Lehmann, Kleinmachnow (DE); Heinz-Ingo Schneider, Baldham (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 11/435,774

(22) Filed: May 18, 2006

(30) Foreign Application Priority Data
May 19, 2005 (DE) 102005023797.5

(51) Int. Cl. B60Q 1/00

(52) U.S. Cl. 362/368

(57) ABSTRACT

A base for a lamp, in particular a high-pressure discharge lamp, has an accommodating area for electronic components of the lamp and a chamber for the purpose of accommodating at least one further electronic component, for example a transformer, an electrical contact element being arranged in the base and connecting a voltage output of the transformer to a power supply line of the lamp via a connecting region. The connecting region is electrically insulated from the accommodating area of the base by a contact cover.

### TECHNICAL FIELD

The invention relates to a base for a lamp, in particular a high-pressure discharge lamp, having an accommodating area for electronic components of the lamp and having a chamber for the purpose of accommodating at least one further electronic component, for example a transformer, an electrical contact element being arranged in the base and connecting a voltage output of the transformer to a power supply line of the lamp via a connecting region. The invention also relates to a lamp provided with such a base and to a method for producing such a lamp.

### BACKGROUND ART

The base according to the invention can in principle be used in a large number of lamps with a base at one end. The main application area of the base, however, should be in high-pressure discharge lamps for headlights, in particular for vehicle headlights, which are surrounded by an outer bulb and are inserted into a base at one end.

A high-pressure discharge lamp having such a base is known, for example, from EP 1 511 130 A1 by the Applicant. With these conventional lamps, a base is used which has a starting transformer arranged in it for the purpose of generating the starting voltage for the discharge lamp and in which an electrical contact element is arranged which connects a voltage output of the starting transformer to a power supply line which is passed out of the discharge vessel of the lamp on the base side. With this solution, the contact element is embedded, in sections, in the base made from plastic in order to improve the electrical insulation. The base has two chambers, a first end of the electrical contact element extending into the first chamber, and the second end of the contact element being accessible from the second chamber. The starting transformer is arranged in the first chamber, and its voltage output is connected to the first end of the contact element, while further electronic components of the starting apparatus of the discharge lamp are accommodated in the second chamber and place fewer demands on the voltage insulation than the starting transformer. The second end of the contact element is accessible from the second chamber in order to be connected to the power supply line which is passed out of the discharge vessel near to the base. For this purpose, the power supply line is inserted into a hole in the second end of the contact element and welded to said contact element. This makes it possible for the starting transformer carrying a high voltage to be arranged physically separate. In order to improve the ability of the lamp base to withstand high voltages, in this solution, the connecting region, which is in a depression, is embedded in an electrically insulating casting compound between the second end of the contact element and the end of the power supply line near to the base, said casting compound providing electrical insulation from the interior of the base.

One disadvantage with such lamps is that the ability of the base to withstand high voltages in many cases does not meet the stringent requirements on the reliability of insulation, since the latter is restricted by the insulating effect of the casting compound used and is dependent on said casting compound being introduced in the connecting region between the contact element and the power supply line. One further disadvantage is the fact that such lamps are complex in terms of their manufacture and cost-intensive owing to the complex filling and curing processes for the casting compound.

### SUMMARY OF THE INVENTION

The invention is based on the object of providing a base for a lamp, in particular for a discharge lamp, a lamp equipped with such a base and a method for producing such a lamp, in the case of which improved electrical insulation is possible compared with conventional solutions given a minimum amount of complexity in terms of apparatus.

This object is achieved by a base for a lamp, in particular a high-pressure discharge lamp, having an accommodating area for electronic components of the lamp and having a chamber for the purpose of accommodating at least one further electronic component, for example a transformer, an electrical contact element being arranged in the base and connecting a voltage output of the transformer to a power supply line of the lamp via a connecting region, wherein the connecting region is electrically insulated from the accommodating area of the base by means of a contact cover. Particularly advantageous embodiments of the invention are described in the dependent claims.

The base according to the invention for a lamp, in particular a high-pressure discharge lamp, has an accommodating area for electronic components of the lamp and a chamber for the purpose of accommodating at least one further electronic component, for example a transformer, an electrical contact element being arranged in the base and connecting a voltage output of the transformer to a power supply line of the lamp via a connecting region. According to the invention, the connecting region is electrically insulated from the accommodating area of the base by means of a contact cover.

The lamp according to the invention has an electrical contact element for the purpose of connecting a voltage output of the transformer to a power supply line of the lamp, the connecting region between the contact element and the power supply line being electrically insulated from the accommodating area of the base by means of a contact cover.

A method according to the invention for producing a lamp, having such a base, is carried out using the following steps:

a) inserting the lamp into the base,

b) connecting the contact element to the power supply line of the lamp, and

c) inserting and fixing a contact cover made from an electrically insulating material, in particular plastic, in a receptacle of the base.

This solution makes improved electrical insulation of the base possible since the ability of the connecting region to withstand high voltages can be adjusted in a defined manner by the selection of the material and the geometrical design of the contact cover. Furthermore, according to the invention the complexity in terms of apparatus during the production of the base is reduced since filling and curing processes which are complex in terms of manufacturing technology, as are required in a solution in accordance with EP 1 511 130 A1, can be dispensed with. As a result, the production costs of the lamp can be considerably reduced compared to the solution cited at the outset.

In accordance with one particularly preferred exemplary embodiment, the contact cover is made from an electrically insulating material, in particular from plastic.

It has proven to be particularly advantageous if the contact cover is a covering disk which is inserted at least in sections into a receptacle of the base and is connected to said receptacle in a cohesive manner. The covering disk makes a simple component configuration of the base possible, in which case the production of the base is further simplified with reduced production costs.

The contact cover preferably has an essentially circular cross section. Owing to its shape, the contact cover can be produced in a simple manner in terms of manufacturing technology.

In order to make it easier to insert the contact cover into the receptacle of the base and to make a defined joint possible, the contact cover preferably has a stepped design.

The contact cover preferably has a thickness t in the range of from approximately 1 to 3 mm, in particular of 1.6 mm.

In accordance with one preferred embodiment of the invention, the contact cover is connected to the base by means of welding, in particular by means of ultrasound welding.

In one variant according to the invention, the contact cover is connected to the base by means of a connecting compound.

An adhesive, in particular a single-component, two-component or multicomponent adhesive based on epoxy, urethane, cyanoacrylate or silicone is preferably used as the connecting compound.

The contact cover and the base preferably form a common surface after welding or adhesive bonding. Owing to the contact cover which ends flush with the base, the physical space for the electrical components of the lamp in the base is not restricted.

In order to further improve the ability of the base to withstand high voltages and the reliability of insulation of the base, in one exemplary embodiment of the invention, the connecting region, in addition to the contact cover, is embedded at least in sections in an electrically insulating casting compound, in particular silicone.

The contact cover is preferably welded to the base after or during its insertion into the base.

In one alternative embodiment of the invention, a connecting compound, in particular an adhesive, is introduced into the connecting region before the contact cover is inserted.

In accordance with one further exemplary embodiment of the invention, the connecting region is embedded in an electrically insulating casting compound before the contact cover is inserted, in order to further improve the ability of the base to withstand high voltages and the reliability of insulation of the base.

### BRIEF DESCRIPTION OF THE DRAWINGS

The invention will be explained in more detail below with reference to a preferred exemplary embodiment. In the drawings:

FIG. 1 shows a schematic illustration of one preferred exemplary embodiment of the base according to the invention with a discharge lamp inserted;

FIG. 2 shows a schematic illustration of the discharge lamp shown in FIG. 1 fixed in the base inner part;

FIG. 3 shows a plan view of the base outer part shown in FIG. 1 before the cover is mounted;

FIG. 4 shows a side view of the base outer part shown in FIG. 3, in a partially sectioned illustration;

FIG. 5 shows a plan view of the base outer part shown in FIG. 3 with a contact cover inserted;

FIG. 6 shows a detailed illustration of the contact cover shown in FIG. 5, and

FIG. 7 shows a detailed illustration of an alternative embodiment of a contact cover.

### BEST MODE FOR CARRYING OUT THE INVENTION

The invention will be explained below with reference to a discharge lamp with a base at one end for a vehicle headlight. As has already been mentioned at the outset, the base according to the invention is, however, in no way restricted to such types of lamps.

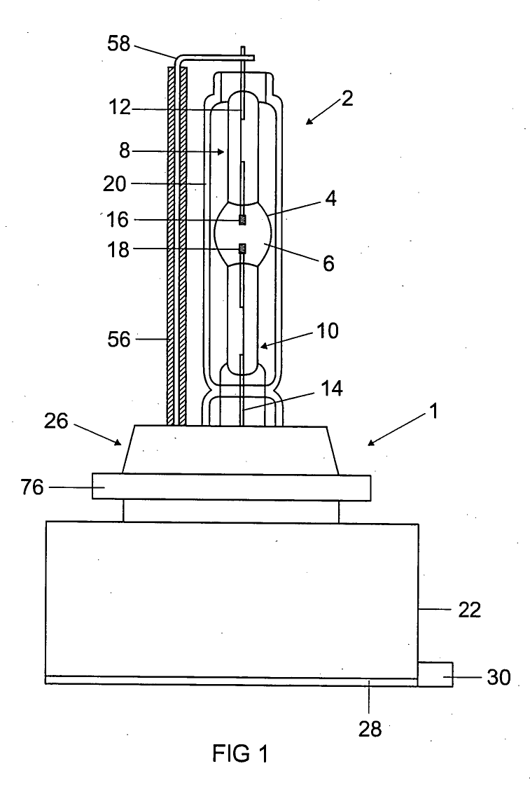

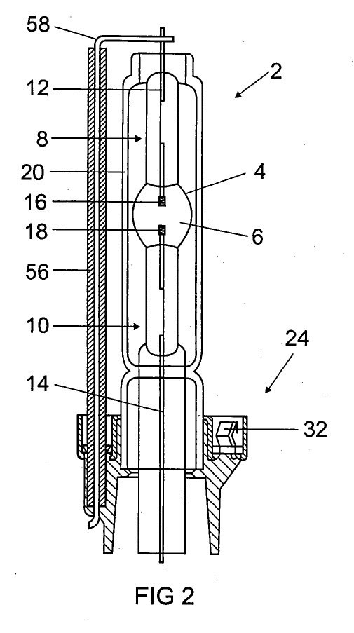

FIG. 1 shows a schematic illustration of a base 1 according to the invention with a high-pressure discharge lamp 2 inserted in said base 1. Said high-pressure discharge lamp 2 has a discharge vessel 4 made from quartz glass having an interior 6 and two diametrically arranged, sealed end sections 8, 10, which each have a power supply line 12, 14 made from molybdenum. Two diametrically arranged electrodes 16, 18 protrude into the interior 6 of the discharge vessel 4, are each connected to one of the power supply lines 12, 14 and form a gas discharge between them during lamp operation. An ionizable filling is enclosed in the interior 6 of the discharge vessel 4, said ionizable filling comprising a high-purity xenon gas and a plurality of metal halides. The discharge vessel 4 is surrounded by an outer bulb 20, which is made from quartz glass which is provided with dopants absorbing ultraviolet radiation. The base 1 essentially comprises a base outer part 22, into which a base inner part 24 is inserted (cf. FIG. 2). The base outer part 22 is in the form of a plastic injection-molded part and has an accommodating section 26 on the lamp side for the purpose of accommodating the base inner part 24. The base 1 can be closed at the bottom by means of a lid 28 and have a female connector 30 for electrical contact-making purposes.

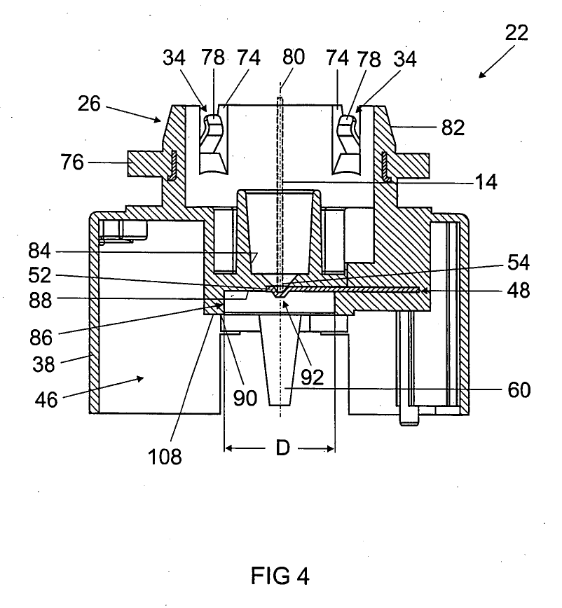

As shown in FIG. 2, which shows the base inner part 24 of the base 1 shown in FIG. 1 with a lamp 2 inserted, the discharge vessel 4 and the outer bulb 20 are fixed in the base inner part 24 made from plastic. In order to mount the base inner part 24 in the accommodating section 26 of the base outer part 22 (cf. FIG. 1), the base inner part 24 is provided with four approximately wedge-shaped cutouts 32 (in FIG. 2 only one of the cutouts is illustrated), which are each arranged offset with respect to one another through 90° and into which fixing means 34 (cf. FIG. 4) of the base outer part 22 engage.

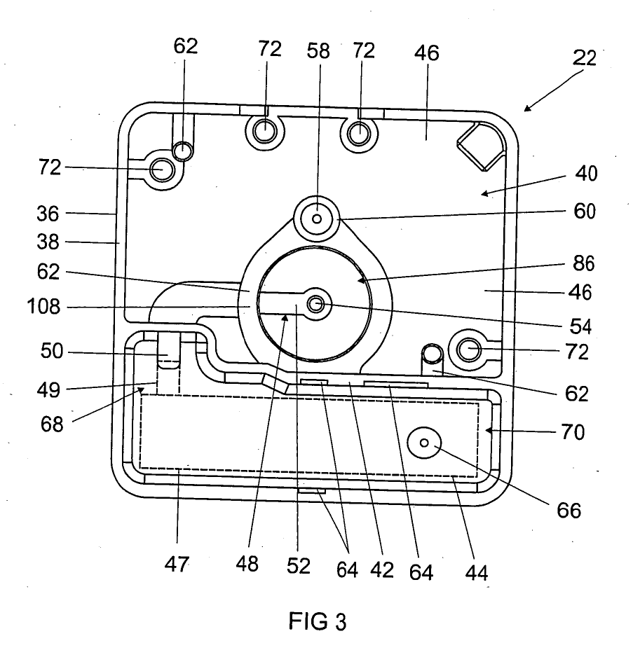

As can be seen in FIG. 3, which shows a plan view of that side of the base outer part 22 (shown in FIG. 1) which is remote from the discharge vessel 4 before the lid 28 is mounted, the base outer part 22 has an essentially square base body 36, which delimits an interior 40 via a side wall 38. The interior 40 is split into two chambers 44, 46 having different sizes by means of a partition wall 42. A rod-core transformer 47 (illustrated using dashed lines in FIG. 3) is arranged in the first chamber 44 (transformer area) and is used as the starting transformer for the pulse starting apparatus (not illustrated) of the high-pressure discharge lamp 2 which is accommodated in the base 1. The second chamber 46 forms an accommodating area for further components (not illustrated) of the pulse starting apparatus. An approximately L-shaped electrical contact element 48 made from stainless steel is embedded in the base outer part 22. The contact element 48 has already been integrated in the base outer part 22 by being sprayed around in a plastic injection molding process as early as when said base outer part 22 is produced, with the result that it is surrounded in sections by the plastic of the base outer part 22 and only two ends 50, 52 of the contact element 48 are accessible for electrical contact-making purposes. The first end 50 of the contact element 48 extends into the transformer area 44 and is connected to a starting voltage output 49, carrying a high voltage, of the rod-core transformer 47 once the rod-core transformer 47 has been mounted. The second end 52 of the contact element 48 is extended radially in sections and is provided with a through-hole 54 for the purpose of accommodating the inner power supply line 14, which is near to the base, of the discharge lamp 2 (cf. FIG. 1). The power supply line 12 of the end section 8, remote from the base, of the discharge vessel 4 is passed via a power return line 58 (cf. FIG. 1), which is surrounded by an insulating sleeve 56, through a hollow web 60 of the base outer part 22 into the accommodating area 46 and is electrically connected to a mounting board (not illustrated), whose shape approximately corresponds to the cross section of the accommodating area 46. For example, the starting capacitor of the pulse starting apparatus and further electronic components of the lamp are arranged on the mounting board (not illustrated). The mounting board is fixed in the accommodating area 46 by means of apertures, in which webs 62 of the base outer part 22 engage, the mounting board being inserted into the base outer part 22 such that the components mounted on the mounting board protrude into the accommodating area 22 of the base outer part. Three guides 64 for the purpose of accommodating corresponding projections on the housing of the rod-core transformer 47 are formed in the side wall 38 of the transformer area 44 and the partition wall 42, with the result that the position of the rod-core transformer 47 in the transformer area 44 is fixed. In addition to the guides 64, a knob-shaped projection 66 is formed on the bottom of the transformer area 44, and this projection 66, together with the first end 50 of the contact element 48, defines the insertion depth of the rod-core transformer 47 in the transformer area 44. The rod-core transformer 47 is electrically insulated and fixed once it has been inserted into the transformer area 44. For this purpose, an interspace 68 between the rod-core transformer 47 and the side walls 38 or the partition wall 42 of the transformer area 44 is filled with an electrically insulating casting compound 70, for example silicone. In order to fix the lid 22 (cf. FIG. 1), four web-shaped fixing elements 72 are formed on the base outer part 22.

As shown in FIG. 4, which shows a side view of the base outer part 22 shown in FIG. 3 in a partially sectioned illustration, the accommodating section 26 of the base outer part 22 is interrupted by four approximately U-shaped cutouts 74, which are arranged offset with respect to one another through 90° and extend at one end up to approximately the level of a flange 76 which is annular at least in sections. In each case one fixing means 34, in the form of a spring lug 78, is arranged as the holding element in the cutouts 74 in the accommodating section 26, said fixing means 34 extending essentially axially parallel to a longitudinal axis 80 of the base outer part 22. The base inner part 24 (cf. FIG. 2) can be fixed in the base outer part 22 by means of the holding elements 78. The accommodating section 26 merges with an insertion taper 82 on the lamp side for the insertion of the base 1 into the headlight (not illustrated).

In order to mount the base inner part 24 in the base outer part 22, the power supply 14 near to the base (indicated by a dashed line) of the discharge lamp 2 is inserted into the immediately adjacent through-hole 54, which is in the form of an embossed nipple, of the second end 52 of the contact element 48 via a tube 84, which is conically constricted in a stepped manner, of the base outer part 22. The conical constriction of the tube 84 in this case makes it easier to insert the power supply line 14 into the through-hole 54 in the contact element 48. On that side of the contact element 48 which is remote from the tube 84, that end of the power supply line 14 which is threaded through the through-hole 54 is welded to the second end 52 of the contact element 48 by means of laser beam welding. On that side of the contact element 48 which is remote from the tube 84, a receptacle 86, which is essentially in the form of a blind hole, is formed in the base outer part 22, the second end 52 of the contact element 48 forming part of a bottom wall 88 of the receptacle 86. The receptacle 86 is provided with a circumferential bevel 90 at one end side.

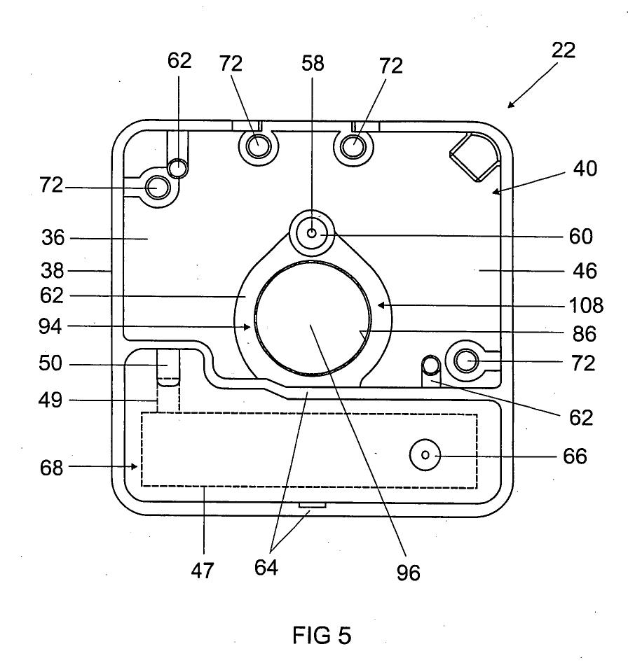

According to the invention, a connecting region 92 between the contact element 48 and the power supply line 14 near to the base is electrically insulated from the accommodating area 46 of the base 1 by means of a contact cover 94. This will be explained in more detail below with reference to FIG. 5.

As can be seen in FIG. 5, which shows the base outer part 22 shown in FIG. 3 with the connecting region 92 closed, the receptacle 86 of the base outer part 22 is closed via the contact cover 94 once the power supply line 14, near to the base, has been welded to the second end 52 of the contact element 48 (cf. FIG. 4). This solution makes improved electrical insulation of the base 1 possible since the ability of the connecting region 92 (cf. FIG. 4) to withstand high voltages can be adjusted in a defined manner by the selection of the material and the geometrical design of the insulating contact cover 94. Furthermore, according to the invention the complexity in terms of apparatus technology during the production of the base 1 is reduced since filling and curing processes which are complex in terms of manufacturing technology, as are required in a solution in accordance with EP 1 511 130 A1, can be dispensed with. As a result, the production costs of the lamp can be considerably reduced compared to the solution cited at the outset.

In the exemplary embodiment illustrated, a covering disk 96 is used as the contact cover 94, and this covering disk 96 is inserted into the receptacle 86 of the base 1 and is connected to said receptacle 86 in a cohesive manner by means of ultrasound welding. For this purpose, the base 1 is clamped into a welding receptacle, the contact cover 94 is partially inserted in the receptacle 86 of the base outer part 22 and caused to oscillate at a high frequency via a sonotrode (not illustrated). At the same time, the contact cover 94 is moved by means of the sonotrode in the direction of the fixed base outer part 22, the plastics being severely heated owing to the friction at the contact points, which results in the plastics being softened and in a cohesive connection between the contact cover 94 and the receptacle 86 of the base outer part 22.

In one additional working step, the connecting region 92 can be embedded at least in sections in an electrically insulating casting compound 98 before the contact cover 94 is introduced (not illustrated). As a result, the ability to withstand high voltages and the reliability of insulation can be further increased in the connecting region 92.

As an alternative to joining the contact cover 94 as described above by means of a welding technique, it is possible to connect the contact cover 94 to the base outer part 22 via a connecting compound (not illustrated). For example, a single-component or multicomponent adhesive based on epoxy, urethane, cyanoacrylate or silicone can be used as a connecting compound.

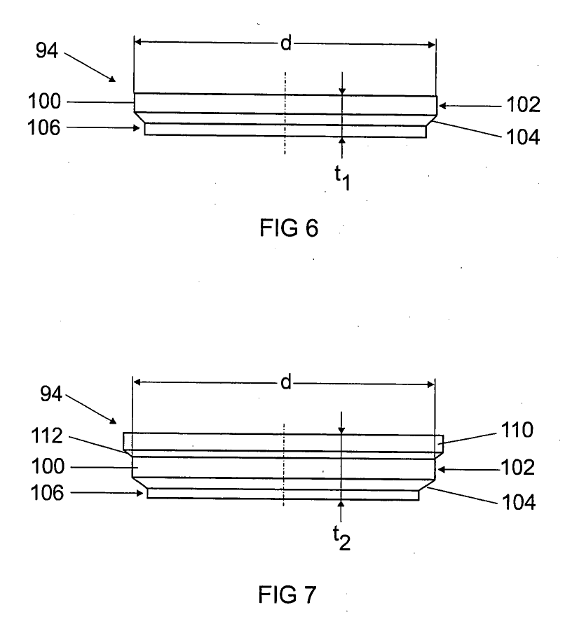

As shown in FIG. 6, which shows a detailed illustration of the contact cover 94 shown in FIG. 5, said contact cover 94 has an essentially cylindrical base body 100, which has a radial collar 102 which merges with an insertion section 106 having a reduced diameter via a circumferential bevel 104 in order to make it easier to insert the contact cover 94 into the receptacle 86 of the base outer part 22 (cf. FIG. 4). The contact cover 94 has a thickness t₁ of 1.6 mm and is made from an electrically insulating thermoplastic. The connection between the base outer part 22 and the contact cover 94 can be improved further by the use of identical plastics. The radial collar 102 has a greater outer diameter d in relation to an inner diameter D (cf. FIG. 4) of the receptacle 86 of the base outer part 22. Owing to the difference in diameter, the contact cover 94 bears against a base surface 108 of the receptacle 86 in the region of the bevel 104 before it is welded to the base outer part 22 (cf. FIG. 5).

During the welding process, the contact cover 94 is partially plastified owing to the temperature development and, by means of the welding pressure applied by the sonotrode, is pinch-sealed into the receptacle 86 and connected to said receptacle 86 in a cohesive manner. After welding, the contact cover 94 can protrude to an extent which can be adjusted by the selection of the welding parameters or can end flush with the base surface 108.

In the case of an alternative joining method, the contact cover 94 can be designed to be smooth, i.e. without a radial collar 102 and with an outer diameter d which corresponds to the inner diameter D of the receptacle of the base outer part 22 or is selected to be slightly smaller. This makes it possible for the contact cover 94 to be inserted into the receptacle 86 and to be welded to it or for the contact cover 94 or the receptacle 86 to be provided with adhesive and for the contact cover 94 to be adhesively bonded into the receptacle 86.

FIG. 7 shows one alternative embodiment of a contact cover 94 according to the invention which differs from the contact cover shown in FIG. 6 merely by an additional radial collar 110, which merges with the radial collar 102 having a reduced diameter d via a circumferential bevel 112. The additional radial collar 110 rests on the base surface 108 (cf. FIG. 3) once the contact cover 94 has been welded into the receptacle 86. As a result, the welding burr produced during welding is covered by the radial collar 110, and a defined insertion depth of the contact cover 94 in the receptacle 86 is achieved. In this exemplary embodiment, the contact cover 94 has a thickness t₂ of approximately 2.4 mm and is likewise made from an electrically insulating thermoplastic.

The essential steps when producing a lamp according to the invention will be explained below with reference to FIGS. 1 to 5. In a first working step, the discharge lamp 2 surrounded by the outer bulb 20 is inserted, with the base inner part 24, into the base outer part 22, and the second end 52 of the contact element 48 is welded to the power supply line 14, near to the base, (cf. FIG. 4) of the discharge lamp 2. Then, as shown in FIG. 5, the contact cover 94 is at least partially inserted into the receptacle 86 of the base outer part 22. In an additional working step, the connecting region 92 can be embedded in an electrically insulating casting compound 98 before the contact cover 94 is inserted. Once the contact cover 94 has been inserted into the base 1, said contact cover 94 is welded to the receptacle 86, for example by means of ultrasound welding. In one alternative exemplary embodiment of the invention, an adhesive is introduced into the connecting region before the contact cover 94 is inserted, and the contact cover 94 is fixed in the receptacle 86 by means of an adhesive bond.

The base 1 according to the invention is not restricted to the described joining technique by means of ultrasound welding; rather any welding process known from the prior art can be used which makes it possible to introduce heat in a defined manner into the welding region. In particular, other friction welding processes or welding processes using heating elements, lasers or infrared light can be used. It is also possible to form the receptacle 86 with a stepped contour in order to improve weldability. In this exemplary embodiment, it is possible to dispense with a stepped design for the contact cover. A cohesive, tight connection between the contact cover 94 and the base 1 is essential to the invention in order that the connecting region 92 is insulated in a manner which is resistant to high voltages.

The invention discloses a base 1 for a lamp 2, in particular for a high-pressure discharge lamp, having an accommodating area 46 for electronic components of the lamp 2 and having a chamber 44 for the purpose of accommodating at least one further electronic component, for example a transformer 47, an electrical contact element 48 for connecting a voltage output of the transformer 47 to a power supply line 14 of the lamp 2 being arranged in the base 1. According to the invention, the connecting region 92 of the contact element 48 is electrically insulated from the accommodating area 46 of the base 1 by means of a contact cover 94.

1. A base for a lamp, in particular a high-pressure discharge lamp, having an accommodating area for electronic components of the lamp and having a chamber for the purpose of accommodating at least one further electronic component, for example a transformer, an electrical contact element being arranged in the base and connecting a voltage output of the transformer to a power supply line of the lamp (2) via a connecting region, wherein the connecting region is electrically insulated from the accommodating area of the base by means of a contact cover.

2. The base as claimed in claim 1, the contact cover being made from an electrically insulating material, preferably a plastic.

3. The base as claimed in claim 1, the contact cover having an essentially circular cross section.

4. The base as claimed in claim 1, the contact cover being a covering disk which is inserted at least in sections into a receptacle of the base.

5. The base as claimed in claim 4, the contact cover having a stepped design.

6. The base as claimed in claim 1, the contact cover having a thickness (t₁, t₂) in the range of from approximately 1 to 3 mm, preferably of 1.6 mm.

7. The base as claimed in claim 1, the contact cover being connected to the base by means of welding, preferably by means of ultrasound welding.

8. The base as claimed in claim 1, the contact cover being connected to the base by means of a connecting compound.

9. The base as claimed in claim 8, the connecting compound being an adhesive, in particular a single-component adhesive or a multicomponent adhesive.

10. The base as claimed in claim 9, the adhesive having an epoxy, urethane, cyanoacrylate or silicone basis.

11. The base as claimed in claim 7, the contact cover and the base forming a common surface after welding or adhesive bonding.

12. The base as claimed in claim 1, the connecting region being embedded at least in sections in an electrically insulating casting compound, in particular silicone.

13. The lamp having a base as claimed in claim 1.

14. A method for producing a lamp, having a base, in particular as claimed in claim 1, an electrical contact element being arranged in the base and connecting a voltage output of a transformer to a power supply line of the lamp via a connecting region, having the following steps:
a) inserting the lamp into the base,
b) connecting the contact element to the power supply line of the lamp, and
c) inserting and fixing a contact cover made from an electrically insulating material, in particular plastic, in a receptacle of the base.

15. The method for producing a lamp as claimed in claim 14, the connecting region) being embedded in an electrically insulating casting compound before the contact cover is inserted.

16. The method for producing a lamp as claimed in claim 14, the contact cover being welded to the base after or during its insertion into the base.

17. The method for producing a lamp as claimed in claim 14, a connecting compound, in particular an adhesive, being introduced into the connecting region before the contact cover is inserted.
